(19) United States
(12) Patent Application Publication
(10) Pub. No.: US 2017/0357738 A1
(43) Pub. Date: Dec. 14, 2017

(54) Process for Merging Parametric Building Information Models

(71) Applicant: Flux Factory, Inc., San Francisco, CA (US)

(72) Inventors: Karl Garske, San Francisco, CA (US); Andrew Zukoski, San Francisco, CA (US); Owen Derby, San Francisco, CA (US); Nick Chim, San Francisco, CA (US); Nate Miller, San Francisco, CA (US)

(73) Assignee: Flux Factory, Inc., San Francisco, CA (US)

(21) Appl. No.: 15/620,628

(22) Filed: Jun. 12, 2017

Related U.S. Application Data
(60) Provisional application No. 62/348,909, filed on Jun. 11, 2016.

(51) Int. Cl. G06F 17/50

(52) U.S. Cl. CPC G06F 17/5004; G06F 2217/04

(57) ABSTRACT

Systems and methods in accordance with various embodiments of the invention can merge local, programmatic design data with parametric building information models. Data for a portion of a structure stored in a local model can be converted from a design format to a common format and transmitted to a BIM merge management system. The BIM merge management system can perform a transformation process to update the information in the local model and/or information in a BIM using the data in the BIM associated with the portion of the structure. The updated data can also be transmitted by the BIM merge management system to a second personal device that converts the data to a design format of a local model on the second device and merges the updated data with the local model on the second device.

### CROSS REFERENCED APPLICATIONS

This application claims priority to U.S. Provisional Patent Application No. 62/348,909, entitled “Process for Merging Parametric Building Information Models” filed Jun. 11, 2016, the disclosure of which is incorporated herein by reference in its entirety.

### FIELD OF THE INVENTION

This invention relates to the storage and updating of models in a Building Information Model (BIM). More particularly, this invention relates to systems and processes for updating a local model stored on a user device with information from a remote system.

### BACKGROUND

Architects, community planners, engineers and the like often use Building Information Models (BIMs) to electronically store and modify designs of communities, buildings, houses and other structures during the planning and construction of these structures. A BIM is a file that stores information about the structure including 3 dimensions drawings and/or other information about a structure and its constituent components. The BIM may include one or more other files or pointers to files with information about these constituent components of the structure.

Often the designing of a structure is a collaborative process with a team of multiple designers contributing to the design. Each individual designer or small team of designers may be working specific portions of the structure. In these cases, the BIM may act at as a repository for storing the information about the various portions worked on by the different designers/teams.

### SUMMARY

Systems and methods for merging parametric building information models are disclosed. In accordance with some embodiments, the systems and methods for updating data in a local model in a personal device with information from a BIM stored by a BIM merge management system are merge the data in the following manner. A personal device of a user obtains a local model including data for a portion of a structure formatted in a particular design format. The personal device generates a common format representation of the local model including data for the portion of the structure formatted in a common format from the local model using the personal device and transmits the common format representation of local model to a BIM merge management system.

The BIM management system retrieves data in a BIM associated with the portion of the structure in the common format of the local model. The data from the BIM retrieved by the BIM management system is formatted in the common format. An update model is generated by the BIM management system that includes data for the portion of the structure in common format representation of the local model by transforming the data in the comparison model with the data from associated with the portion of the structure from the BIM and transmits the update model from the BIM merge management system to a second personal device.

The second personal device converts the data for the portion of the structure in the update model to a second design format of data in a second local model maintained by the second personal device. Conflicts between the data in the update model and data in the local model maintained by the second personal device are identified by the second personal device and resolutions for each of the identified conflicts are obtained by the second personal device and the data from the update model into the local model maintained by the second personal device based on the resolutions of the identified conflicts by the second personal device.

### BRIEF DESCRIPTION OF THE DRAWINGS

FIG. 1 illustrates a system that includes devices that provide systems and methods for merging information from models maintained by various devices in accordance with an embodiment of the invention.

FIG. 2 illustrates a block diagram of components in a processing system in devices including a user device and/or a server in accordance with an embodiment of the invention.

FIG. 3 illustrates a flow diagram of a process performed by a user device to share data from a local model in accordance with an embodiment of the invention.

FIG. 4 illustrates a flow diagram of a process performed by a BIM merge management system to transform data from a local model received from a first user device and to share the data with a local model maintained by another device in accordance with an embodiment of the invention.

FIG. 5 illustrates a local model converted into a JSON format for transmission to a BIM merge management system in accordance with an embodiment of the invention.

FIG. 6 illustrates a data flow diagram for a transformation process performed on a received model by a BIM merge management system in accordance with an embodiment of the invention.

FIG. 7 illustrates an updated model in JSON format generated by a BIM merge management system in accordance with an embodiment of the invention.

FIG. 8 illustrates a screen shot of a merge dialog window showing conflicts in accordance with an embodiment of the invention.

FIG. 9 illustrates a flow diagram of a process for updating a local model on a user device in accordance with an embodiment of the invention.

### DETAILED DESCRIPTION OF THE INVENTION

Turning now to the drawings, systems and methods for merging data from a local model generated on a user device with data in models maintained by other systems in accordance with various embodiments of the invention are described. The systems and methods in accordance with some embodiments of this invention provide a visual programming environment that allows for data exchange and collaboration between designers of a structure without the need to convert the data between various formats. A designer may input data on a user device in a desired format using an application of their choosing. Applications that may be used include, but are not limited to, Grasshopper, Dynamo, Sketchup, Revit, Excel, AutoCad, 3ds Max, Google Sheets, Rhino, ArcGIS, Tableau, ETABS, and GSA. The data is then sent to a remote system that stores the BIM. A BIM merge management system transforms the data in accordance with the information stored in a BIM related to the project and transmits the data to another device for merging into a model maintained by the device. This allows all of the designers in a multi-user collaboration to work on and edit the BIM.

In accordance with some embodiments of the invention, the process for sharing data in a local model generated by a personal device is performed in the following manner. A designer uses a design application being executed by a user to generate a local model of a portion of a structure. Design applications that may be used include, but are not limited to, Grasshopper, Dynamo, Sketchup, Revit, Excel, AutoCad, 3ds Max, Google Sheets, Rhino, ArcGIS, Tableau, ETABS, and GSA. The user then selects the local model for sharing and/or updating. A plug-in on the user device that operates with the design application can convert the format of the local model from the format of the design application to a common format. In accordance with some embodiments, the common format is Java Script Object Notation (JSON) to generate a comparison model. As can readily be appreciated, transformation of the local model and/or the portion of the BIM into which the local model is being merged into a common format simplifies comparisons between data for describing the same portion of the structure in the different models.

The user device then transmits the local model in the common format to the BIM merge management system for sharing and/or updating. In accordance with some embodiments, of the invention, the BIM merge management system is provided by a server system. In accordance with many embodiments of the invention, the BIM merge management system is provided by a “cloud” of server systems. For purposes of this discussion, a “cloud” is a group of systems that communicate with one another over the Internet to provide the functionality of a system.

In accordance with many embodiments, the BIM merge management system can retrieve a copy of the BIM or at least a relevant portion of the BIM related to the received local model. The relevant portion of the BIM may be identified through the use of identifiers and/or other common parameters such as spatial coordinates. The BIM merge management system can use the BIM or a relevant portion of the BIM to transform the data from the local model to conform to the data in the relevant portion of the BIM to generate an update model and/or update the data in the copy of the BIM based on conflict resolution processes performed by the system. A second device may then request or be designated to receive the update model in accordance with some various embodiments of the invention. The update model can be transmitted to the second device.

In several embodiments, a second device that receives the updated model uses a plug-in to a design application to convert the updated model from the common format to the format of the design application. For example, an updated model can be in the JSON format and can be converted to the format used by Grasshopper. This conversion may include converting parameter values including, but not limited to, units of measurements from values in the common format to values in the application format in accordance with some embodiments of the invention. Elements of the update model and the local model (and in some embodiments, the elements from previous update models) are identified and matched. In accordance with some embodiments of the invention, the identifying and matching may be performed using unique identifiers assigned by one of the users and/or a team of users. The matched elements in the local model of the second device and update model (and in some embodiments, previous versions of update models) can then be compared to identify conflicts in the data in the various models. In accordance with a number of embodiments, one or more possible resolutions to each identified conflict may also be generated. In accordance with many embodiments, the conflicts and/or possible resolutions to each conflict are stored in a merge dialog. As can readily be appreciated, transformation of the local model and the portion of the BIM in to which the local model is being merged into a common format simplifies the comparison. The choice of a common format is largely dependent upon the requirements of a given application and can alternatively be the format utilized by the BIM or the local modelling tool.

The conflicts and/or the possible resolutions can then be presented to the user. In accordance with some embodiments, the merge dialog storing the conflicts and/or resolutions is provided in a GUI to the user. The user uses the GUI to select and/or input resolutions to each conflict. The resolutions received from the user can be used to merge the data from the update model to the local model of the second device. In accordance with some embodiments, the update model is then stored for use in future conflict and/or resolution identification processes in the future.

Systems and processes for updating and/or sharing data in a local model using a BIM storages system in accordance with some embodiments of this invention are described in further detail below.

### Network Overview

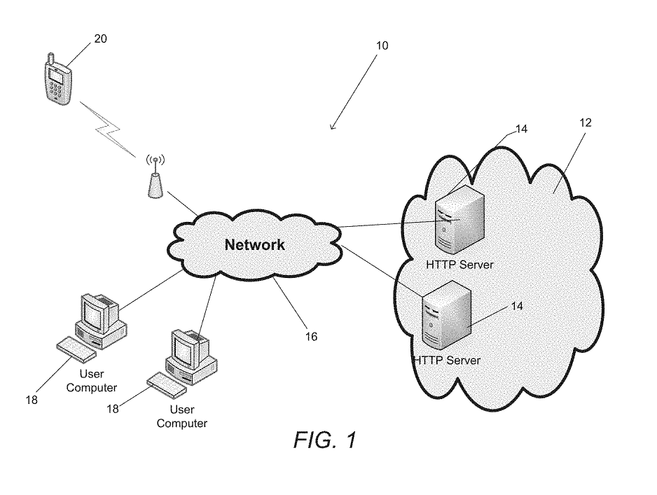

A network that includes user devices and systems that provide a BIM merge management system that perform processes for allowing a user to share data from a local model with data from a BIM and/or update data in a local model maintained by a second device in accordance with some embodiments of this invention is shown in FIG. 1. Network 10 includes communications network 16. Communications network 16 is a network such as the Internet that allows devices connected to network 16 to communicate with other connected devices. Each of one or more server systems 14 is connected to network 16. In accordance with some embodiments, two or more server system 14 communicate with one another over the network to form a cloud server system 12 to allow the servers 14 of cloud system 14 to perform processes of a provided system in a distributed manner. Those skilled in the art will recognize that while two servers are shown, any number of servers may be included in cloud server system 12. Furthermore, one or more database servers (not shown) may be communicatively connected to any one of servers 14 to store data and or BIMs.

Users interact with the BIM merge management system using a device executing an application that communicates with processes performed by the BIM merge management system. Some examples of appropriate devices include (but are not limited to) devices 18 and 20 that connect to network 16. In the shown embodiment, personal device 18 is shown as a desktop computer that is connected via a conventional “wired” connection to network 16. However, personal device 18 may be a desktop computer, a laptop computer, a smart television, an entertainment gaming console, automobile infotainment system or any other device that connects to network 16 via a “wired” connection. Mobile device 20 connects to network 16 using a wireless connection. A wireless connection is a connection that uses Radio Frequency (RF) signals, Infrared signals, or any other form of wireless signaling to connect to network 16. In FIG. 1, mobile device 20 is a mobile telephone. However, mobile device 20 may be a mobile phone, Personal Digital Assistant (PDA), a tablet, a smartphone, or any other type of device that connects to network 16 via wireless connection without departing from this invention.

### Processing Systems

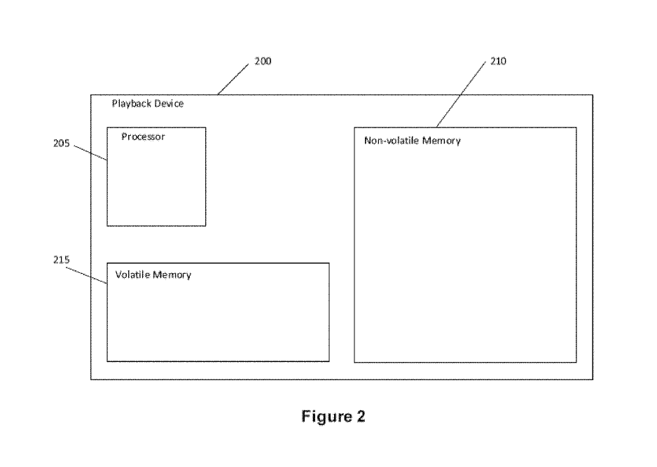

An example of a processing system that executes instructions to perform processes that provide applications, such as the processes that provide and interact with a BIM merge management system in the devices shown in FIG. 1 in accordance with some embodiments of this invention is shown in FIG. 2. One skilled in the art will recognize that a particular processing system may include other components that are omitted for brevity without departing from this invention. The processing device 200 includes a processor 205, a non-volatile memory 210, and a volatile memory 215. The processor 205 is a processor, microprocessor, controller, or a combination of processors, microprocessor, and/or controllers that performs instructions stored in the volatile 215 or non-volatile memory 210 to manipulate data stored in the memory. The non-volatile memory 210 can store the processor instructions utilized to configure the processing system 200 to perform processes including processes in accordance with embodiments of the invention and/or data for the processes being utilized. In other embodiments, the processing system software and/or firmware can be stored in any of a variety of non-transient computer readable media appropriate to a specific application. A network interface is a device that allows processing system 200 to transmit and receive data over a network based upon the instructions performed by processor 205. Although a processing system 200 is illustrated in FIG. 2, any of a variety of processing system in the various devices can be configured to provide the methods and systems in accordance with embodiments of the invention.

Process for Sharing and/or Updating a Model on Personal Devices

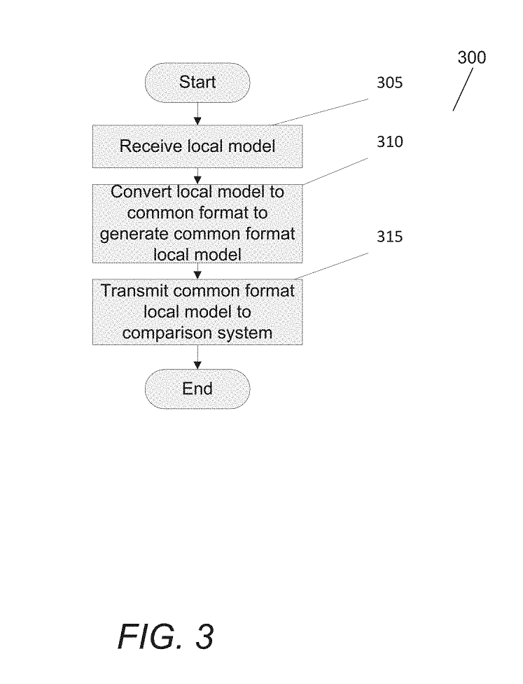

In accordance with some embodiments of the invention, a user is a member of a team that is designing a structure. Data for the structure can be stored in a BIM by the BIM merge management system. The designer can generate a local model of a portion of the structure using a design application. After the local model is completed or during the building of the local model, the user may want to share the data from the local model with the rest of the design team by merging data from the local model into the BIM and/or updating a local model of the portion of the structure maintained on one more other devices. A process performed by a user device to share data in a local model of a portion of a structure stored in a BIM using a BIM merge management system in accordance with an embodiment of the invention is shown in FIG. 3.

A user works on a design of a portion of a structure by generating a local model using a design application. In accordance with various embodiments of the invention, the design application may be one or more of the following applications including, but not limited to, Grasshopper, Dynamo, Sketchup, Revit, Excel, AutoCad, 3ds Max, Google Sheets, Rhino, ArcGIS, Tableau, ETABS, and GSA. Each of these application stores the data in a particular data format.

Process 300 can be used to share the data in the local model using a BIM merge management system in accordance with the shown embodiment of the invention. In accordance with some embodiments of the invention, process 300 may be provided by a plug-in to the design application provided by a system provider. In accordance with some other embodiments, process 300 may be integrated into the design application.

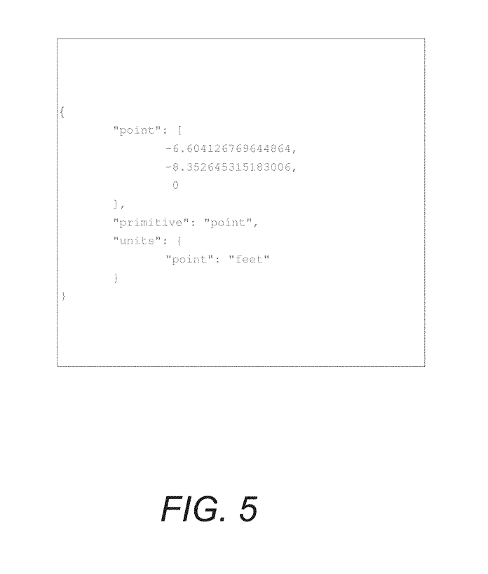

In the process 300, a local model to share and/or update is received (305). The local model was generated by a particular design application and the data in the local model is in the particular format of the particular design application. The process 300 can convert the data of the local model from the particular format of the design application to a common format for use in transmission and performing comparisons to generate a common format representation of the local model (310). In accordance with many embodiments, the common format is Java Script Object Notation (JSON). An example of JSON script generated from a local model for a column in a structure in accordance with an embodiment of the invention is shown in FIG. 5. As can readily be appreciated, transformation of the local model and/or the portion of the BIM into which the local model is being merged into a common format simplifies comparisons between data for describing the same portion of the structure in the different models.

Returning to FIG. 3, the process 300 transmits the common format local model from the user device to a BIM merge management system (315). In accordance with some embodiments, the transmission is over a network such as the Internet. In accordance with many embodiments, security measures such as encryption may be used for the transmission. While the process shown in FIG. 3 relies upon the user device to generate the comparison model, in other embodiments the user device simply transmits the local model to the BIM merge management system and the BIM merge management system generates the comparison model.

Although a process for updating and/or sharing data in a local model using a BIM merge management system in accordance with an embodiment of the invention is described with respect to FIG. 3, other processes including processes that omit, add, and/or combine steps may be used in accordance with some other various embodiments of the invention.

### Local Model Updating Process Performed by Personal Devices

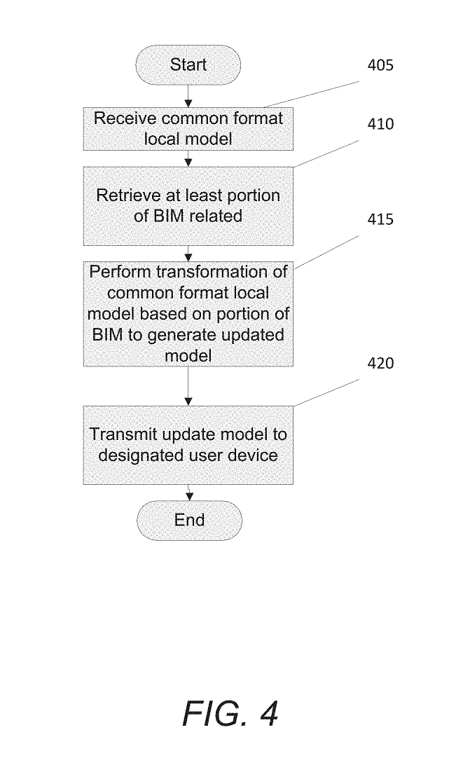

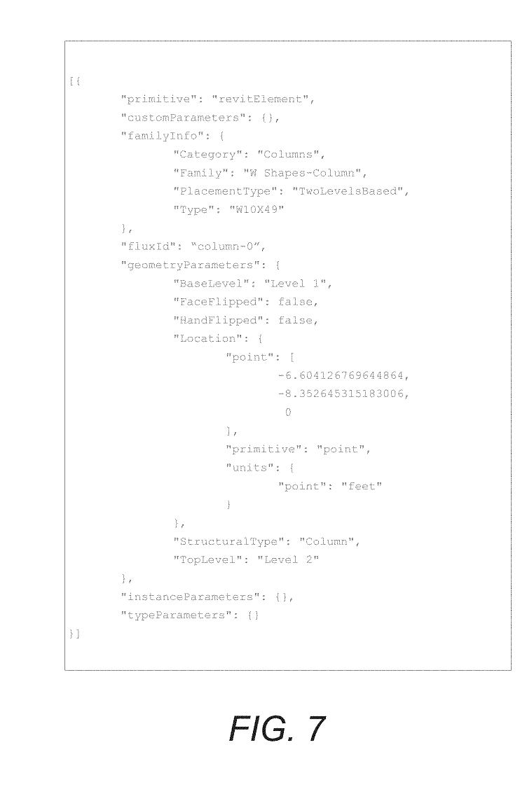

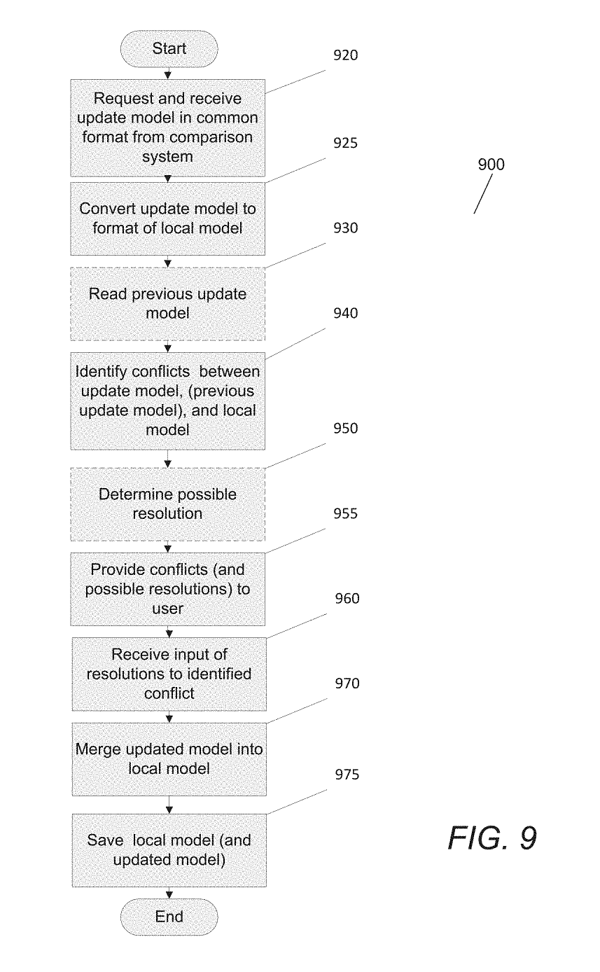

In accordance with some embodiments of the invention, the data received from a local model on a personal device may be provided to other devices to update local models on a second device that include data relating to the portion of the structure. A process for updating a local model maintained by the second device is shown in FIG. 9. In accordance with some embodiments of this invention, a local model including data for a portion of a structure is a model generated using a particular designer application. In accordance with some other embodiments, the local model may be a BIM that includes information for the portion of the structure. Process 900 receives an update model from the BIM merge management system (920). The update model is in the common format and includes transformed data. For purposes of this discussion, transformed data is data from the common format local model received by the BIM merge management system that has been added to, deleted from and/or modified in some manner as a result of design activities of a user using a design application. A more complete discussion of an update model and the generation of the update model is given below with respect to the process performed by the BIM merge management system shown FIG. 4. An example of a programmatic design script in an update model for the column model shown in FIG. 5 is shown in FIG. 7. In FIG. 7, additional information about the column has been added to the model.

The process 900 converts the data in the update model from the common format to the format of the local model maintained by the second device (925). In accordance with some embodiments, the conversion may be made based upon the design application performing the process 900. In accordance with many embodiments, the conversion includes converting parameter values from the common format to values in the format of the local model on the device performing the conversion. Examples of parameter values include, but are not limited to, units of measurements.

The process 900 may also optionally retrieve one or more previously stored update models previously received for the local model (930). Conflicts between the data in the local model, the update model and optionally, one or more previously received update models are determined by the process 900 (940). In accordance with many embodiments, the identification of conflicts includes identifying the same element in each of the various models and comparing data associated with the identified elements. In accordance with a number of these embodiments, the identification of elements is performed using identifiers assigned by a designer or team of designers to signify a particular element. Conflicts in each element can then be recorded. In a number of embodiments, the conflicts are recorded in a merge dialog for future use.

In addition, the process 900 may determine one or more possible resolution for each conflict identified (950). The following table shows a possible results table for a comparison algorithm used in accordance with an embodiment of the invention.

| Comparison with | Comparison with | Solution Proposed | Can Merge Without |
|---|---|---|---|
| Local | Server | to User | User Input |
| The element was | The element was not | The element is safe to | Yes |
| received from Flux, | previously received | add into the local | |
| and it does not exist in | from Flux | model because it is | |
| the local model | | new | |
| The element was | The element was | The element should | Yes |
| received from Flux, | previously received | not be added into the | |
| and it does not exist in | from Flux | local model because | |
| the local model | | it was removed locally | |
| The element exists in | The element was | The element should | Yes |
| the local model, but it | previously received | be removed from the | |
| was not received from | from Flux | local model | |
| Flux | | | |
| The element was | The element was | The element does not | Yes |
| received from Flux, | received from Flux, | need to be updated in | |
| and its parameters | and its parameters | the local model | |
| are the same as the | are the same as the | | |
| element in the local | element previously | | |
| model | received from Flux | | |
| The element was | The element was | The element | Yes |
| received from Flux, | received from Flux, | parameters in the | |
| and it contains one or | and its parameters | local model should | |
| more parameters that | are the same as the | not be updated, | |
| are different from the | element previously | because the changes | |
| element in the local | received from Flux | only occurred locally. | |
| model | | | |
| The element was | The element was | The element | Yes |
| received from Flux, | received from Flux, | parameters in the | |
| and it contains one or | and its parameters | local model should be | |
| more parameters that | are the same as the | updated to match the | |
| are different from the | values previously | element parameters | |
| element in the local | received from Flux | received from Flux | |
| model | | | |
| The element was | The element was | No solution can be | No |
| received from Flux, | received from Flux, | proposed | |
| and it contains one or | and one or more | | |
| more parameters that | parameters are | | |
| are different from the | different from the | | |
| element in the local | element previously | | |
| model | received from Flux | | |

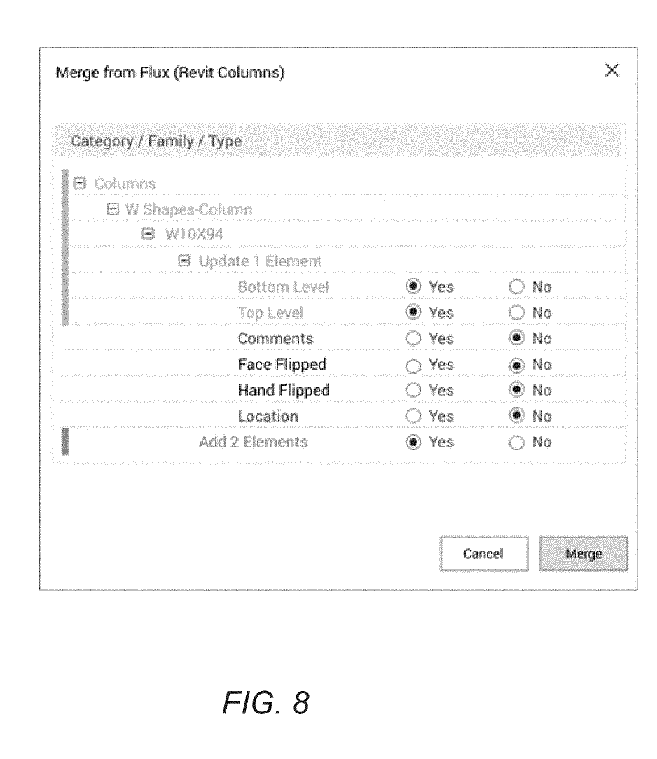

The process 900 provides the possible conflicts (and possibly the possible resolutions to each conflict) to the user (955). In accordance with some embodiments, the conflicts and possible resolutions can be provided in a dialog box in a GUI to the user. An example of a screen shot of a dialog box in a GUI showing a merge dialog in accordance with an embodiment of the invention is shown in FIG. 8.

Returning to FIG. 9, the process 900 can receive inputs from the user indicating resolutions to the identified conflicts (960). In accordance with some embodiments, the inputs may be selections of possible resolution for a conflict shown in a dialog box. The input resolutions are then used to merge the data from the update model into the local model (970). The local model and possibly the received update model are stored in memory (975) for future use and the process 900 ends.

Although a process for updating data in a local model using a BIM merge management system in accordance with an embodiment of the invention is described with respect to FIG. 9, other processes including processes that omit, add, and/or combine steps and/or that are performed on a secure system and provided to a personal device may be used in accordance with some other various embodiments of the invention.

### Transformation of Data Performed by a BIM Merge Management System

A BIM merge management system can store a BIM that includes the data for a structure and/or communicate with a server system that stores a BIM. A user may desire to place data from a local model of at least a portion of the structure generated by the user into the BIM or share the data in the model with a model maintained on another device. A process performed by a BIM merge management system for transforming data in a model to update data in a BIM and/or provide updated data to a local model maintained by another device based on data in the BIM in accordance with an embodiment of the invention is shown in FIG. 4.

In the process 400, a common format local model is received by the BIM merge management system from a user device (405). In accordance with some embodiments of the invention, the common format model includes data in the common format as described above with respect to FIG. 3. In accordance with some other embodiments, the local model may include data in a format of the design application used to generate the model. In accordance with these embodiments, the process 400 converts the data in the local model from the format of the design application to the common format used for comparisons to generate the common format local model. In accordance with a number of embodiments, the comparison format is JSON.

The process 400 retrieves data for at least a portion of the structure that is relevant to the data in the common format representation of the local model (415). In accordance with some embodiments, identifiers in the data may be used to determine the relevant data. In accordance with some other embodiments, parameters in the data from the comparison model may be used to determine the data in the BIM that is relevant to the data in the common format representation of the local module. In accordance with some of these embodiments, spatial coordinates are used to determine the data in the BIM relevant to the data in the common format representation of the local model.

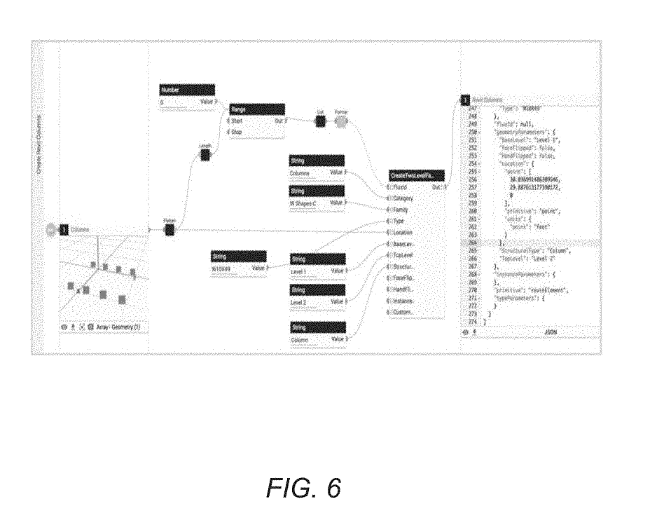

The process 400 performs a transformation of the data in the common format representation of the local model to generate an update model that includes data relevant to the portion of the structured modeled in the common format representation local model (420). The transformation may include adding, deleting, and/or changing of data in the common format local model. In accordance with many embodiments, the transformation may also modify data stored in the copy of the BIM maintained by the BIM merge management system to share data with others using the BIM. A flow diagram of a process performed to transform data from a comparison model to generate an update model in accordance with an embodiment of the invention is shown in FIG. 6. The update model is then transmitted to one or more designated personal devices for use in updating a local model maintained by the designated personal device as described above with respect to FIG. 9 and the process 400 ends. In accordance with some embodiments, the BIM merge management system maintains a list of devices that share data from local models that are to be updated when a local model is received from a particular device. In accordance with some other embodiments, a subsequent user device receives an update model in response to a request for information about the portion of the structure modeled by the local model.

Although a variety of processes for updating and/or sharing data in a BIM performed by a BIM merge management system in accordance with an embodiment of the invention is described with respect to FIG. 4, other processes including processes that omit, add, and/or combine steps may be used in accordance with some other various embodiments of the invention.

Although the present invention has been described in certain specific aspects, many additional modifications and variations would be apparent to those skilled in the art. It is therefore to be understood that the present invention may be practiced otherwise than specifically described, including various changes in the implementation without departing from the scope and spirit of the present invention. Thus, embodiments of the present invention should be considered in all respects as illustrative and not restrictive.

What is claimed is:

1. A method for updating data in a local model in a personal device with information from a BIM stored by a BIM merge management system comprising:
obtaining a local model including data for a portion of a structure formatted in a particular design format in a personal device;
generating a common format representation of the local model including data for the portion of the structure formatted in a common format from the local model using the personal device;
transmitting the common format representation of local model from the user device to a BIM merge management system;
retrieving data in a BIM associated with the portion of the structure where the data from the BIM is formatted in the common format;
generating a update model including data for the portion of the structure in common format representation of the local model by transforming the data in the comparison model with the data from associated with the portion of the structure from the BIM using the BIM merge management system;
transmitting the update model from the BIM merge management system to a second personal device;
converting the data for the portion of the structure in the update model to a second design format of data in a second local model maintained by the second personal device using the second personal device;
identifying conflicts between the data in the update model and data in the local model maintained by the second personal device using the second personal device;
obtaining resolutions for each of the identified conflicts using the second personal device; and
merging the data from the update model into the local model maintained by the second personal device based on the resolutions of the identified conflicts using the second personal device.

2. The method of claim 1 wherein the particular design format and the second design format are the same design format.

3. The method of claim wherein the particular design format and the second design format are the same design format.
